(19) United States
(12) Patent Application Publication
(10) Pub. No.: US 2004/0039960 A1
(43) Pub. Date: Feb. 26, 2004

(54) Method and apparatus for automatic hibernation after a power failure

(76) Inventor: Reza Kassayan, Redwood City, CA (US)

Correspondence Address: Reza Kassayan, 550 Shannon Way # 6311, Redwood City, CA, 94065, US

(21) Appl. No.: 10/226,987

(22) Filed: Aug. 23, 2002

(51) Int. Cl. H04L 1/22

(52) U.S. Cl. 714/14

(57) ABSTRACT

An automatic hibernation approach to recover the status and the data of the all applications running on a computer is employed after a power failure. There is a unit which monitors the power supply and detects the power failure. When a power failure occurs, the supply of power is temporarily transferred to a battery and the operating system is informed that a power failure has happened. The operating system runs a software to store the status of the drivers, the status of the operating system, and the memory. The start sequence is switched to a special start sequence and the source of power is returned to the power supply before a shutdown takes place. When the power comes back, the special start sequence restores the memory and the status of the operating system and the drivers. Finally, every operation is back to normal.

### RELATED APPLICATIONS

None

### BACKGROUND OF THE INVENTION

This invention relates to automatic hibernation, more particularly, to recovery of data and applications after a power failure for a computer.

Every computer has a unit to supply power. Most computers use a power supply which is connected to an AC power line. Software applications depend on hardware and hardware does not work without power. Therefore, when there is a power outage, the user will lose all the applications. One way to avoid this application loss is to use an uninterruptible power supply (UPS). However, using a UPS is an additional cost which should be avoided if possible. Another approach is to automatically save data on a hard disk to make it possible for the software to recover the data later. Not every software provides such an automatic save option. Also, even if such an option exists, all data between the time of the last auto-save and the time of the power outage is lost.

### SUMMARY OF THE INVENTION

The current invention provides an approach to recover the status and the data of the all applications running on a computer after a power failure. First, there is a unit which monitors the power supply and detects the power failure. When a power failure occurs, the supply of power is temporarily transferred to a battery and the operating system is informed that a power failure has happened. Then, the operating system runs a software to store the status of the drivers, the status of the operating system, and the memory on a storage device. The final step before shutdown is to prepare the system for the return of the power. This is done by switching the start sequence to a special start sequence and returning the source of power to the power supply. A shutdown happens at the end of this procedure.

When the power comes back, the special start sequence restores the memory and the status of the operating system and the drivers. Then, every operation is back to normal.

### BRIEF DESCRIPTION OF THE DRAWINGS

FIG. 1 presents a hardware configuration in accord with the principles of this invention;

FIG. 2 presents a block diagram of a power failure procedure in accord with the principles of this invention;

FIG. 3 presents a software procedure to prepare for power failure in accord with the principles of this invention; and

FIG. 4 presents a block diagram of a procedure to recover all the data and applications in accord with the principles of this invention.

### DETAILED DESCRIPTION OF THE INVENTION

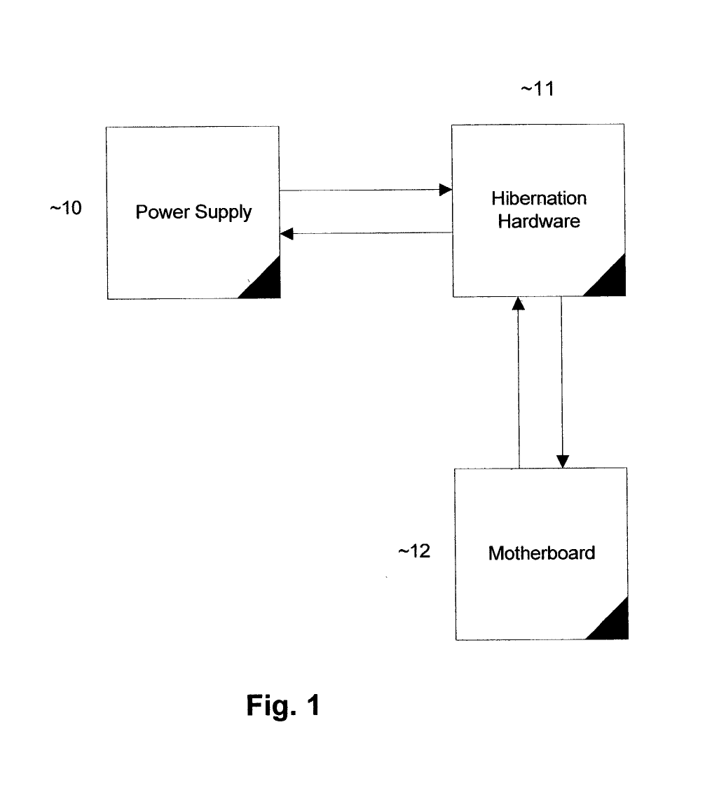

FIG. 1 presents a hardware arrangement that can benefit from automatic hibernation. This is a configuration that in connection with a software makes it possible to recover all the information and the status of the applications running on a computer. In one embodiment of the current invention which is shown in FIG. 1, Block 10 is a power supply and Block 12 is a mother board. Block 11 consists of an additional hardware that can operate as an interface between the power supply and the mother board. In a different embodiment, Block 11 can be integrated in Block 10. In still another embodiment, Block 11 is part of Block 12.

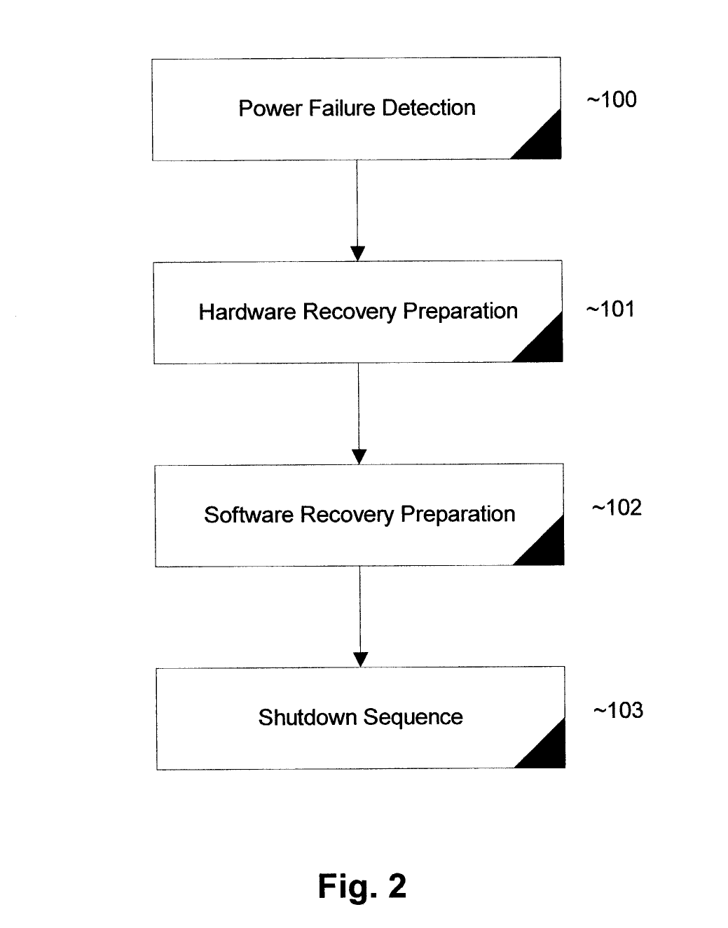

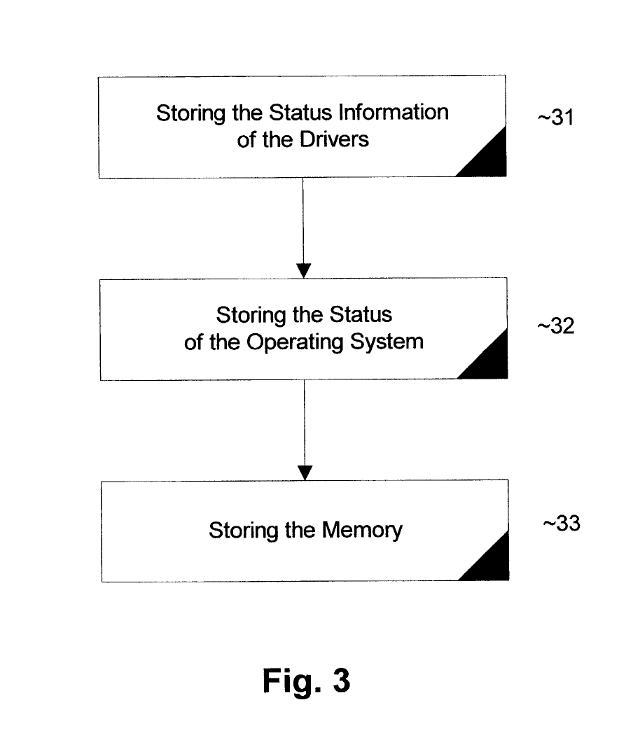

FIG. 2 presents a flowchart for a process to prepare the computer for recovery after a power failure. This procedure happens at the time of power failure. It includes both hardware and software. Block 100 uses part of the hardware Block 11 in FIG. 1 to detect a power failure. Different methods can be used to generate such a signal. In one embodiment, a power failure is announced if the DC voltage of the power supply is less than a certain threshold for a time period of T ms. The output of Block 100 initiates a hardware procedure in Block 101. First, the power source is transferred from the power supply to a battery. This allows the system to continue its operation and complete the procedure. The procedure prepares the computer for recovery next time when the power is available. After the power is supplied by the battery, the operating system is informed about the power failure. In one embodiment, this is done by a hardware interrupt which is detected by the operating system. In another embodiment, the power key is used for this purpose. Block 102 is a software procedure which is run by the operating system and is started after receiving the signal from Block 101. The software procedure in Block 102 is shown in FIG. 3 and includes the following steps. First, the procedure stores the status information of the drivers on a storage device in Block 31. Then, it stores the status of the operating system in Block 32. Finally, the procedure in Block 33 stores all of the available memory on the storage device and starts the shutdown sequence of Block 103. The shutdown sequence in Block 103 is a combination of hardware and software. It returns the power source from the battery back to the power supply after changing a flag in operating system. The effect of this flag change is to enable a special start sequence next time when the power returns.

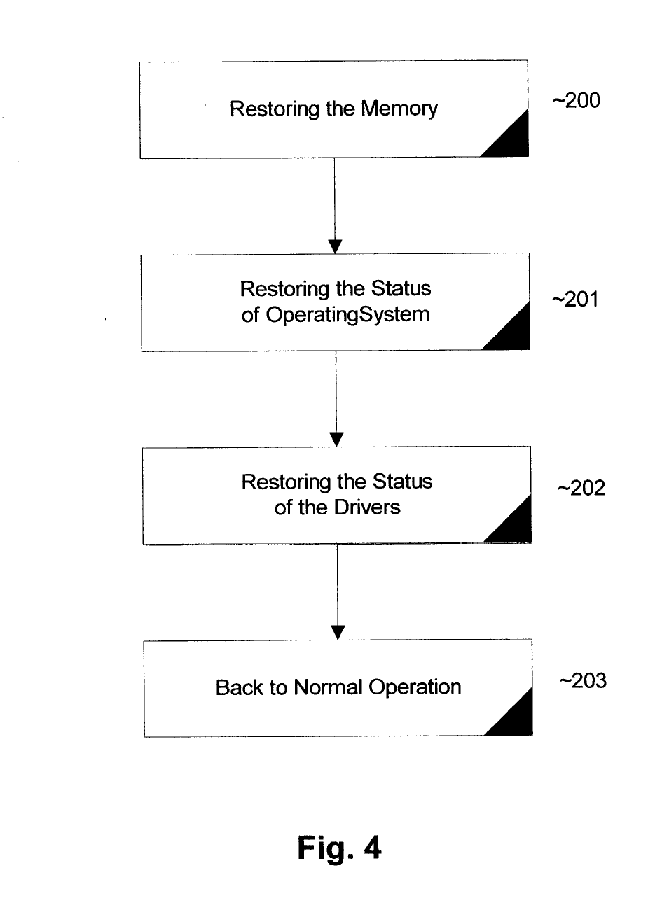

FIG. 4 shows the required procedure to recover all the running applications when the power comes back. This is a software procedure. Step 200 restores the memory by reading all the values from the storage device and writing them in the corresponding memory. Step 201 restores the status of the operating system by reading the corresponding information from the storage device. Step 202 restores the status of the drivers. Finally, Step 203 returns every operation back to normal.

We claim:

1. An automatic hibernation method and apparatus comprising:
(a) Power failure detection for developing a plurality of signals to announce a power failure;
(b) Transferring power from the power supply to a battery, responsive to said plurality of power failure signals;
(c) Informing the operating system about the power failure;
(d) Storing a plurality of the status information for a plurality of the drivers;
(e) Storing a plurality of the status of the operating system;
(f) Storing a plurality of the available memory;
(g) Changing the starting process of operating system to a special start sequence; and
(h) Returning the power source from the said battery to the power supply.

2. The method and apparatus of claim 1 where said power failure detection comprises of a hardware that announces the said power failure if the DC voltage of the power supply is less than a certain threshold for a specific time period.

3. The method and apparatus of claim 1 where said status information for a plurality of the drivers is stored on a hard disk.

4. The method and apparatus of claim 1 where said status of the operating system is stored on a hard disk.

5. The method and apparatus of claim 1 where said memory information is stored on a hard disk.

6. The method and apparatus of claim 1 where said special start sequence comprises:
(a) Restoring the memory;
(b) Restoring the status of the operating system;
(c) Restoring the status of the drivers; and
(d) Returning every operation back to its status before the said power failure.

7. The method and apparatus of claim 1 where some of the said drivers are disabled and the status of the other drivers is stored on the storage device.

8. The method and apparatus of claim 7 where said power failure detection comprises of a hardware that announces the said power failure if the DC voltage of the power supply is less than a certain threshold for a specific time period.

9. The method and apparatus of claim 7 where said status information for a plurality of the drivers is stored on a hard disk.

10. The method and apparatus of claim 7 where said status of the operating system is stored on a hard disk.

11. The method and apparatus of claim 7 where said memory information is stored on a hard disk.

12. The method and apparatus of claim 7 where said special start sequence comprises:
(a) Restoring the memory;
(b) Restoring the status of the operating system;
(c) Restoring the status of the drivers;
(d) Enabling the disabled drivers; and
(e) Returning every operation back to its status before the said power failure.

13. A method for recovery after the power is back in accordance with claim 1, comprising:
(a) Restoring the memory;
(b) Restoring the status of the operating system;
(c) Restoring the status of the drivers; and
(d) Returning every operation back to its status before the said power failure.

14. A method for recovery after the power is back in accordance with claim 7, comprising:
(a) Restoring the memory;
(b) Restoring the status of the operating system;
(c) Restoring the status of the drivers;
(d) Enabling the disabled drivers; and
(e) Returning every operation back to its status before the said power failure.
